(19) United States
(12) Patent Application Publication
(10) Pub. No.: US 2026/0177179 A1
(43) Pub. Date: Jun. 25, 2026

(54) QUICK CONNECT FEMALE COUPLER STRUCTURE

(71) Applicant: FOSITEK CORPORATION, New Taipei City (TW)

(72) Inventors: An-Szu Hsu, New Taipei City (TW); Yan-Jian Cheng, New Taipei City (TW)

(21) Appl. No.: 19/008,181

(22) Filed: Jan. 2, 2025

(30) Foreign Application Priority Data
Dec. 20, 2024 (TW) 113149901

(51) Int. Cl. F16L 37/413

(52) U.S. Cl. CPC F16L 37/413

(57) ABSTRACT

A quick connect female coupler structure includes an outer sleeve internally defining a receiving space and having a radially inward annular stop section formed around a lower end thereof; a fixed member having a lower end formed into a limiting section to rest on the stop section of the outer sleeve; a spring fitted around the fixed member; a movable member axially movably fitted around an upper end of the fixed member; and a coupling sleeve having the fixed member received therein with a lower end thereof pressed on the limiting section and assembled to the outer sleeve. With the above arrangements, the fixed member is stably held by the outer sleeve and the coupling sleeve to an axially centered position in the outer sleeve; and the quick connect female coupler structure has simplified structure, low failure rate, reliable connection, and good airtightness.

This application claims the priority benefit of Taiwan patent application number 113149901 filed on Dec. 20, 2024, the disclosure of which is hereby incorporated by reference in its entirety.

### FIELD OF THE INVENTION

The present invention relates to a female coupler structure, and more particularly, to a quick connect female coupler structure for water cooling.

### BACKGROUND OF THE INVENTION

The existing server has highly increased computing performance, but the computing unit therein also produces more heat. Since there is a plurality of servers mounted in one server cabinet and the servers are closely arranged in the server cabinet with a relatively small space left between them, it is impossible to provide an additional thermal module for each of the servers to dissipate the heat produced by them. Therefore, water cooling has been adopted to dissipate heat from the servers in the server cabinet. Since the servers have highly precision electronic elements provided therein, it is necessary to prevent the pipes in various pipeline systems from leakage at their joints to avoid any damage to the electronic elements caused by leakage in the water cooling pipeline system. To prevent leakage from occurring, most water cooling pipelines for servers use hard or metal pipes, and a male and a female coupler are correspondingly provided on the server (movable side) and the server cabinet (fixed side) for connection end to end, so that the pipes at the movable side and the fixed side can be quickly connected to or disconnected from each other. Usually, there would be a small tolerance in the radial dimensions of the male and the female coupler when they are connected to each other.

Further, it is possible the male coupler and the female coupler are different in their specifications to have unmatched or incompatible connection lengths, causing difficulty in controlling the depth by which the male coupler is plugged into the female coupler. When the male coupler is plugged too deep into the female coupler, a fixed member in the female coupler to serve as a water path switch valve is subjected to a large force exceeded its stress, which will cause positional deviation or backward movement of the switch valve, and the deviated or backward moved switch valve may not be returnable to its initial position to shut off the water path to thereby cause leakage. As shown in FIG. 1, a conventional female coupler 7 includes a single sleeve 71 that internally defines a passage for receiving a fixed member 73 therein. A C-ring 72 is provided at a lower end of the single sleeve 71 for holding the fixed member 73 in place and providing a place for the fixed member 73 to abut thereon, so as to prevent the fixed member 73 from separating from the single sleeve 71. In the case a male coupler (not shown) is used to plug into the female coupler 7 but has a length not matching with the female coupler 7 or is plugged too deep into the female coupler 7, an exceeded stress will occur to cause damage to the C-ring 72 or separation of the C-ring 72 from the lower end of the single sleeve 71, bringing the fixed member 73 rest on the C-ring 72 to deviate or separate from an axially centered position in the single sleeve 71. Eventually, the fixed member 73 serving as the switch valve could not be returned to its initial position to shut off the water path and leakage will occur. It is therefore tried by the inventor to develop an improved quick connect female coupler structure that can overcome the above-mentioned drawback in the conventional female coupler structure.

### SUMMARY OF THE INVENTION

To effectively solve the problems in the conventional female coupler structure, a primary object of the present invention is to provide a quick connect female coupler structure, which provides a stable valve fixing structure to facilitate successful quick connection of a male coupler to a female coupler.

To achieve the above and other objects, the quick connect female coupler structure according to the present invention includes an outer sleeve, a fixed member, a spring, a movable member, and a coupling sleeve.

The outer sleeve internally defines a receiving space and includes a radially inward extended annular stop section provided around a lower end thereof.

The spring is fitted around the fixed member, and the movable member is axially movably fitted around an upper end of the fixing member. The fixed member includes a lower end formed into a limiting section for abutting on the stop section of the outer sleeve.

The coupling sleeve has the fixed member received therein with a lower end thereof pressing on the limiting section and assembled to the outer sleeve.

According to the present invention, the outer sleeve and the coupling sleeve together stably hold the fixed member to an axially centered position in the female coupler structure. When connecting a male coupler to the quick connect female coupler structure, simply apply a force to the male coupler. The fixed member would not deviate from the axially centered position in the male coupler structure, even when the force applied to the male coupler is relatively large, or when the male coupler has specification and length not matching with the female coupler structure. Therefore, the quick connect female coupler structure of the present invention advantageously has simplified structure, low failure rate, reliable connection, and good airtightness while ensures stable mounting of the fixed member in the female coupler structure.

### BRIEF DESCRIPTION OF THE DRAWINGS

The structure and the technical means adopted by the present invention to achieve the above and other objects can be best understood by referring to the following detailed description of the preferred embodiment and the accompanying drawings, wherein

FIG. 1 is an assembled sectional view of a conventional quick connect female coupler structure;

FIG. 2 is an assembled perspective view of a quick connect female coupler structure according to a preferred embodiment of the present invention for connecting with a male coupler;

FIG. 3 is an exploded perspective view of the quick connect female coupler structure according to the preferred embodiment of the present invention;

FIG. 4 is an assembled sectional view of the quick connect female coupler structure according to the preferred embodiment of the present invention; and

FIG. 5 is an assembled sectional view showing the quick connect female coupler structure according to the preferred embodiment of the present invention is connected with a male coupler.

### DETAILED DESCRIPTION OF THE PREFERRED EMBODIMENTS

The present invention will now be described with a preferred embodiment thereof.

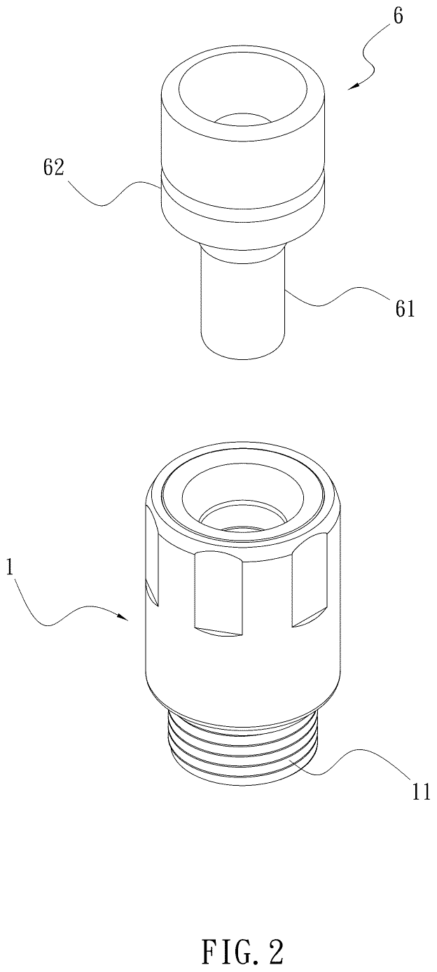

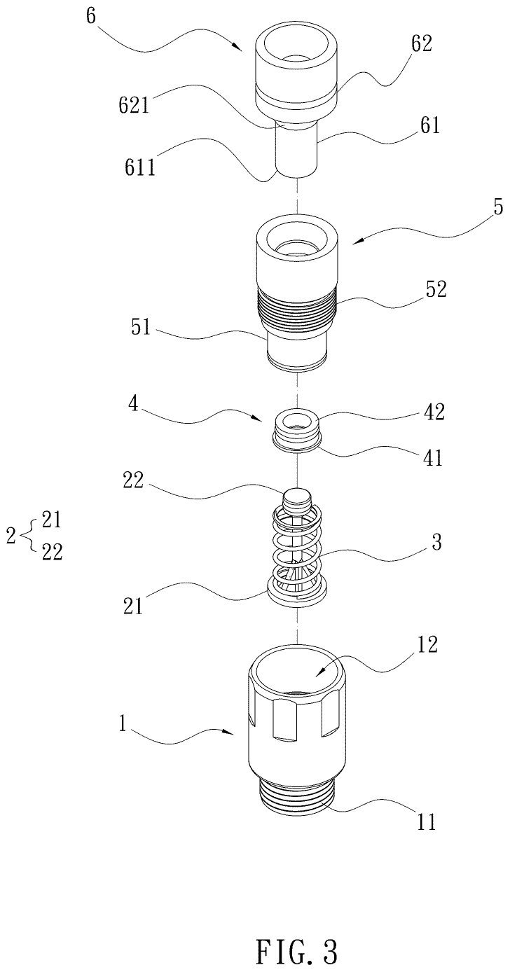

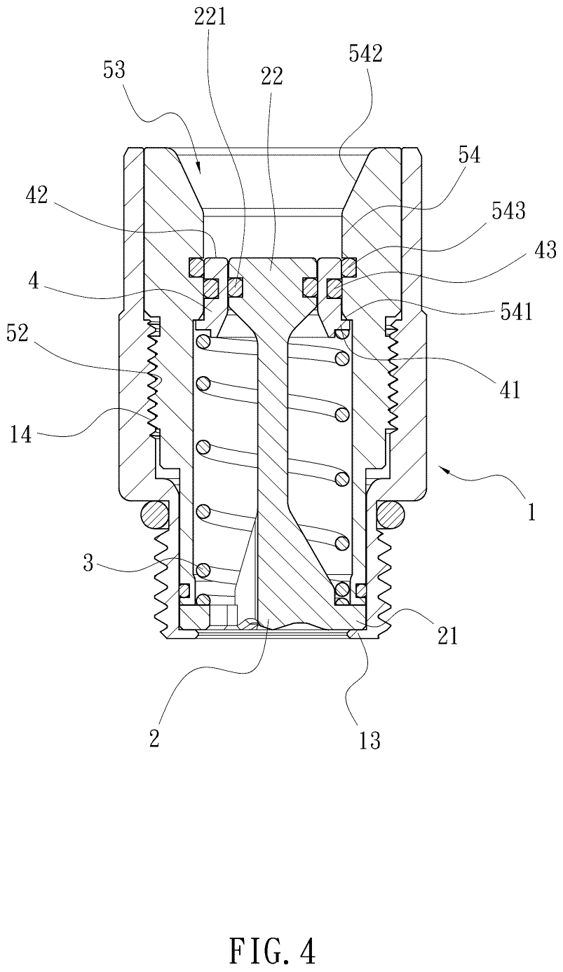

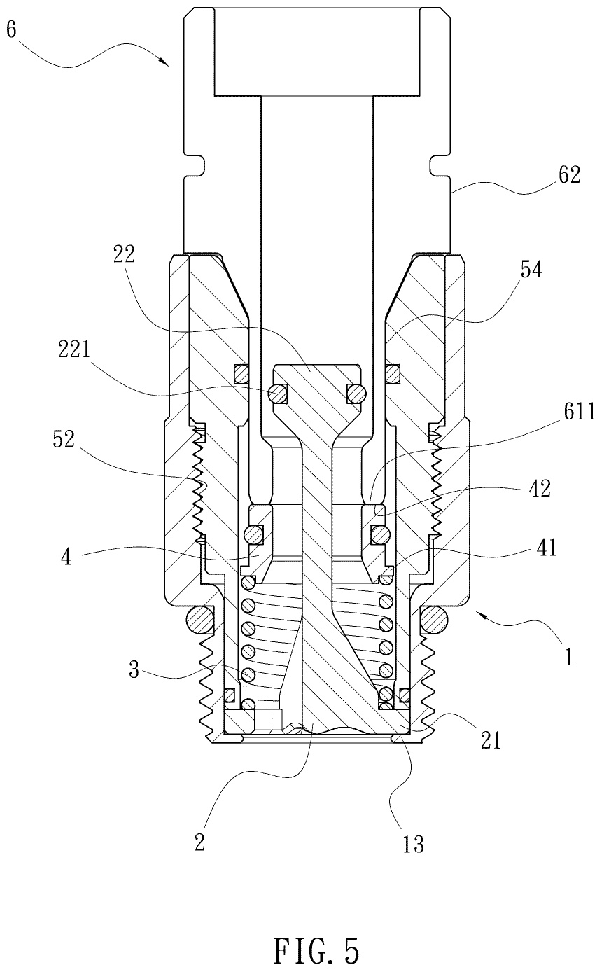

Please refer to FIGS. 2 and 3, which are assembled and exploded perspective views, respectively, of a quick connect female coupler structure according to a preferred embodiment of the present invention; and to FIGS. 4 and 5, which are assembled sectional view of the quick connect female coupler structure of the present invention before and after being connected with a male coupler, respectively.

As shown in FIGS. 2 and 3, the quick connect female coupler structure of the present invention includes an outer sleeve 1, a fixed member 2, a spring 3, a movable member 4, and a coupling sleeve 5. The quick connect female coupler structure of the present invention is configured for a male coupler 6 to plugged thereinto to achieve the effect of quickly connection of the male coupler 6 with the quick connect female coupler structure.

The outer sleeve 1 defines an internal receiving space 12 and is provided on an inner wall surface with a threaded section 14. The outer sleeve 1 has a lower portion being formed into a connection section 11, via which the quick connect female coupler structure can be connected to another device. The outer sleeve 1 is provided at a lowermost end with a radially inward extended annular stop section 13, which is a radially inward extended annular platform located in around the lowermost end of the outer sleeve 1 to provide a stable supporting effect, such that an object abutted on the stop section 13 is well supported without the risk of being deviated or separated from the outer sleeve 1, allowing the object on the stop section 13 to be limited to a position perpendicular to an axial direction. In a preferred embodiment of the present invention, the outer sleeve 1 is an integrally formed structure.

The fixed member 2 is disposed in the outer sleeve 1 and includes a limiting section 21 radially outward projected from a lower end thereof for upward pressed against a lower end of the coupling sleeve 5. That is, the limiting section 21 of the fixed member 2 is abutted on the stop section 13 of the outer sleeve 1. In other words, the stop section 13 of the outer sleeve 1 limits the fixed member 2 from moving in the axial direction, so that the fixed member 2 is confined in the outer sleeve 1 and stably rest on the stop section 13 without the risk of separating from a bottom of the outer sleeve 1. The spring 3 is fitted around the fixed member 2 with a bottom end of the spring 3 pressed against the limiting section 21 of the fixed member 2. The fixed member 2 further includes a radially outward expanded section 22 formed at an upper end thereof. A first annular sealing member 221 is fitted around an outer periphery of the radially outward expanded section 22 while being in contact with an inner wall surface of the movable member 4, so as to achieve a waterproof sealing effect.

The movable member 4 is provided around the upper end of the fixed member 2. Specifically, the movable member 4 is a hollow member being movably fitted around the radially outward expanded section 22 at the upper end of the fixed member 2. Since the movable member 4 has an inner diameter larger than an outer diameter of the radially outward expanded section 22, the movable member 4 is axially movable relative to the radially outward expanded section 22. The movable member 4 includes a radially outward protruded annular portion 41 located around a bottom end thereof and a connection end surface 42 provided on around a top end surface thereof. The spring 3 fitted around the fixed member 2 has a top end pressed against an underside of the annular portion 41 and the coupling sleeve 5 can be threaded into the outer sleeve 1 to press a stepped portion 541 of the coupling sleeve 5 against an upper side of the annular portion 41, such that the annular portion 41 is held to a first position and the movable member 4 is also limited to the first position. The movable member 4 has a second annular sealing member 43, which is fitted around a body portion of the movable member 4 located between the annular portion 41 and the connection end surface 42. The second annular sealing member 43 is in tight contact with an inner wall surface 54 of the coupling sleeve 5 to provide a waterproof sealing effect.

The coupling sleeve 5 has the fixed member 2 received therein with its lower end pressed on the limiting section 21 of the fixed member 2 and assembled to the outer sleeve 1. The coupling sleeve 5 internally defines a plugging passage 53 and the male coupler 6 has a plug section 61 for extending into the plugging passage 53. The inner wall surface 54 of the coupling sleeve 5 includes the stepped portion 541 and an axially inward tapered guiding surface 542. The upper part of the inner wall surface 54 of the coupling sleeve 5 is radially protruded into the plugging passage 53 to form the stepped portion 541. Specifically, the upper part of the inner wall surface 54 of the coupling sleeve 5 is protruded radially inward relative to a lower part of the inner wall surface 54, so that a stepped configuration is formed at a joint of the upper and the lower part of the inner wall surface 54. Therefore, the stepped portion 541 has the function of limiting an object correspondingly abutted thereon from moving upward axially. The tapered guiding surface 542 is located at an uppermost edge of the inner wall surface 54 of the coupling sleeve 5 to annularly extend along the inner wall surface 54. A third annular sealing member 543 is provided on around the inner wall surface 54 and is in contact with an outer surface of the movable member 4 to provide a waterproof sealing effect. The coupling sleeve 5 is externally provided on around a middle part with a thread 52 for meshing with the threaded section 14 provided on around the inner wall surface of the outer sleeve 1. The coupling sleeve 5 has a lower part formed into an engagement section 51, which can be extended into the receiving space 12 in the outer sleeve 1. In the present invention, the coupling sleeve 5 is an integrally formed structure.

Since the outer sleeve 1 has a bore size larger than an outer diameter of the coupling sleeve 5, the coupling sleeve 5 can be threaded into the outer sleeve 1. When moving the coupling sleeve 5 into the receiving space 12 of the outer sleeve 1, it is the engagement section 51 of the coupling sleeve 5 that enters the receiving passage 12 first. The coupling sleeve 5 is then rotated for the thread 52 thereof to mesh with the threaded section 14 of the outer sleeve 1, such that the coupling sleeve 5 is locked to the outer sleeve 1. When the coupling sleeve 5 is fully threaded into the outer sleeve 1, an end surface of the coupling sleeve 5 is flush with that of the outer sleeve 1.

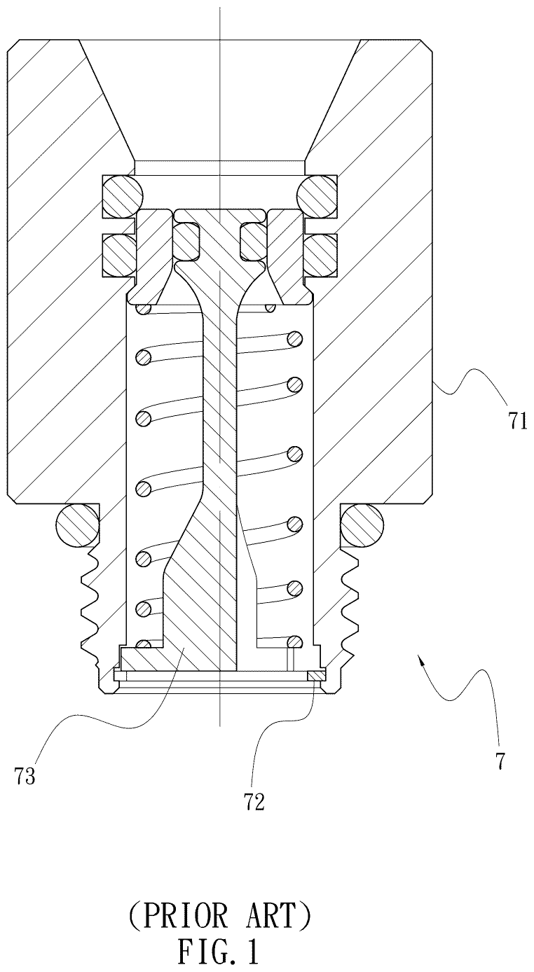

In the present invention, while the quick connect female coupler structure can be assembled in the following described procedures, it is understood there are also other feasible ways to complete the assembling of the quick connect female coupler structure without being limited to the illustrated embodiment. Please refer to FIGS. 1 to 3. To assemble the quick connect female coupler structure of the present invention, first place the fixed member 2 in the outer sleeve 1. Due to the stop section 13 radially inward formed around the lowermost end of the outer sleeve 1, the fixed member 2 would eventually rest on the stop section 13. Then, fit the spring 3 around an outer side of the fixed member 2 and downward press the movable member 4 against the spring 3. Lastly, thread the coupling sleeve 5 into the outer sleeve 1. In the course of threading the coupling sleeve 5 into the outer sleeve 1, the fixed member 2 is clamped by between the stop section 13 of the outer sleeve 1 and the lower end of the coupling sleeve 5 (i.e. a lower end of the engagement section 51) and is accordingly, stably held between the coupling sleeve 5 and the outer sleeve 1, so that the fixed member 2 is limited to an axially centered position in the female coupler structure without the risk of deviating or separating from the outer sleeve 1 when a relatively large force is applied to connect the male coupler 6 to the quick connect female coupler structure or when the male coupler 6 has specification and length not matching those of the female coupler structure.

Please refer to FIGS. 3 and 5. The male coupler 6 includes a plug section 61 and a neck section 62. The plug section 61 has a lowermost end formed into a plugging contact surface 611, and the neck section 62 has an abutting surface 621 formed around a lower portion thereof. When the male coupler 6 is connected to the quick connect female coupler structure of the present invention, the male coupler 6 will be moved into the plugging passage 53 in the coupling sleeve 5 with the plug section 61 of the male coupler 6 being abutted against the movable member 4. In more detail, the plugging contact surface 611 at the lowermost end of the plug section 61 is in contact with the connection end surface 42 of the movable member 4, and the abutting surface 621 of the neck section 62 is in contact with the tapered guiding surface 542 of the coupling sleeve 5.

When a user applies an external force to the male coupler 6 for the same to move downward, the applied external force will be transmitted to the movable member 4, causing the movable member 4 to compress the spring 3 that is pressed against the annular portion 41 formed at the lower end of the movable member 4, so that the spring 3 is elastically compressed and deformed. Since the spring 3 is fitted on around the outer side of the fixed member 2 with the bottom end of the spring 3 pressed against the limiting section 21 of the fixed member 2, the external force compressing the spring 3 is further transmitted to the limiting section 21 of the fixed member 2. However, since the limiting section 21 of the fixed member 2 is limited between the stop section 13 of the outer sleeve 1 and the lower end of the coupling sleeve 5, the fixed member 2 is prevented from moving axially and is accordingly, firmly held in place in the outer sleeve 1. Meanwhile, the applied external force is offset at the stop section 13 of the outer sleeve 1.

In brief, the quick connect female coupler structure of the present invention is formed by assembling the outer sleeve 1, the fixed member 2, and the coupling sleeve 5 to one another. With this structural design, the fixed member 2 can be firmly limited in the quick contact female coupler structure without the risk of deviating or separating from the outer sleeve 1 due to a large force applied to connect the male coupler 6 to the female coupler structure or due to unmatched specification and length of the male coupler 6 with the female coupler structure. Therefore, it is able to overcome the problems or disadvantages in the conventional female coupler 7, which uses a C-ring 72 to support and fix the fixed member 73 in place but the C-ring 72 tends to become damaged or separated from the sleeve 71 due to a large external coupling force or a male coupler having unmatched specification with the female coupler 7 to cause deviation of the fixed member 73 from the C-ring 72 or from a position corresponding to a centerline of the female coupler 7; or in a worse condition, the fixed member serving as a valve is not returnable to its initial position for shutting off the water path to thereby result in leakage of the water cooling system.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A quick connect female coupler structure, comprising:
an outer sleeve internally defining a receiving space and including a radially inward extended annular stop section provided around a lower end thereof;
a fixed member having a spring fitted around an outer side thereof and a movable member axially movably fitted around an upper end thereof; and the fixed member including a lower end formed into a limiting section, and the limiting section being rest on the stop section of the outer sleeve; and
a coupling sleeve having the fixed member received therein with a lower end of the coupling sleeve pressed on the limiting section and assembled to the outer sleeve.

2. The quick connect female coupler structure as claimed in claim 1, wherein the outer sleeve is provided on an inner wall surface with a threaded section and has a lower part formed into a connection section; and the outer sleeve being connectable to another device via the connection section.

3. The quick connect female coupler structure as claimed in claim 1, wherein the fixed member includes a radially outward expanded section formed at an upper end thereof; the radially outward expanded section having a first annular sealing member fitted therearound, and the first annular sealing member being in contact with an inner wall surface of the movable member to provide a waterproof sealing effect.

4. The quick connect female coupler structure as claimed in claim 3, wherein the movable member is a hollow member for axially movably fitted on around the radially outward expanded section at the upper end of the fixed member; and the movable member including a radially outward protruded annular portion provided around a bottom end thereof for pressing against a top end of the spring and a connection end surface provided on around a top end thereof.

5. The quick connect female coupler structure as claimed in claim 1, wherein the movable member has a second annular sealing member fitted on around an outer side thereof; and the second annular sealing member being in contact with an inner wall surface of the coupling sleeve to provide a waterproof sealing effect.

6. The quick connect female coupler structure as claimed in claim 1, wherein the coupling sleeve internally defines a plugging passage for a plug section of a male coupler to plug thereinto; and the coupling sleeve including a stepped portion formed on an inner wall surface thereof and an axially inward tapered guiding surface formed in around an upper part of the inner wall surface.

7. The quick connect female coupler structure as claimed in claim 2, wherein the coupling sleeve has a third annular sealing member fitted on around an inner wall surface thereof; the third annular sealing member being in contact with an outer surface of the movable member to provide a waterproof sealing effect; the coupling sleeve being externally provided with a thread for meshing with the threaded section on the inner wall surface of the outer sleeve; and the coupling sleeve having a lower part formed into an engagement section which is for entering the receiving space of the outer sleeve.

8. The quick connect female coupler structure as claimed in claim 1, wherein the coupling sleeve has an end surface being flush with an end surface of the outer sleeve when the coupling sleeve is fully threaded into the outer sleeve.

9. The quick connect female coupler structure as claimed in claim 1, wherein the spring has a bottom end pressed against the limiting section of the fixed member.
